(19) United States
(12) Patent Application Publication
(10) Pub. No.: US 2018/0349777 A1
(43) Pub. Date: Dec. 6, 2018

(54) CONDUCTING FORWARD REASONING IN PRODUCTION SYSTEM

(71) Applicant: INTERNATIONAL BUSINESS MACHINES CORPORATION, Armonk, NY (US)

(72) Inventors: Akira Koseki, Sagamihara (JP); Shuichi Shimizu, Tokyo (JP); Kohji Takano, Tokyo (JP)

(21) Appl. No.: 15/612,207

(22) Filed: Jun. 2, 2017

(51) Int. Cl. G06N 5/02; G06F 3/06

(52) U.S. Cl. CPC G06N 5/025; G06F 3/0673; G06F 3/064; G06F 3/0604

(57) ABSTRACT

A method, computer system, and a computer program product for conducting forward reasoning is provided. The present invention may include conducting the forward reasoning, wherein the forward reasoning includes selecting a rule from a plurality of rules stored in a rule base and executing an action, wherein the rule is associated with a condition satisfied by internal states stored in a working memory, and wherein the action is associated with the condition. The present invention may also include detecting the action is creating a one-time object. The present invention may then include conducting the forward reasoning with a first new context in response to the detected one-time object, wherein the one-time object is stored as one of the internal states in the working memory. The present invention may further include deleting the one-time object in response to a completion of the forward reasoning with the first new context.

### BACKGROUND

The present invention relates generally to the field of computing, and more particularly to conducting forward reasoning in a production system.

Recently, various techniques have been known regarding conducting forward reasoning in a production system. The production system is a system which includes internal states, rules and conducts, for example, the forward reasoning by firing one or more rules matching the internal states. The production system has been used for an expert system, a control system, a cognitive system or the like.

### SUMMARY

Embodiments of the present invention disclose a method, computer system, and a computer program product for conducting forward reasoning. The present invention may include conducting the forward reasoning, wherein the forward reasoning includes selecting a rule from a plurality of rules stored in a rule base and executing an action, wherein the rule is associated with a condition satisfied by internal states stored in a working memory, and wherein the action is associated with the condition. The present invention may also include detecting the action is creating a one-time object. The present invention may then include conducting the forward reasoning with a first new context in response to the detected one-time object, wherein the one-time object is stored as one of the internal states in the working memory. The present invention may further include deleting the one-time object in response to a completion of the forward reasoning with the first new context.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a block diagram of a production system according to an exemplary embodiment of the present invention;

FIG. 2 illustrates a flowchart representing an example of a processing flow of a function “Fire_rules( )” executed by the production system;

FIG. 3 illustrates a flowchart representing an example of a processing flow of a function “Process_object(one-time-object)” executed by the production system;

FIGS. 4A and 4B illustrate an explanatory diagram of erasure of internal states created by the production system; and

FIG. 5 illustrates an example of a hardware configuration of a production system according to an exemplary embodiment of the present invention.

### DETAILED DESCRIPTION

Hereinafter, an exemplary embodiment of the present invention will be described in detail with reference to the attached drawings.

It is to be noted that the present invention is not limited to the exemplary embodiment presented below and may be implemented with various modifications within the scope of the present invention. In addition, the drawings used herein are for purposes of illustration, and may not show actual dimensions.

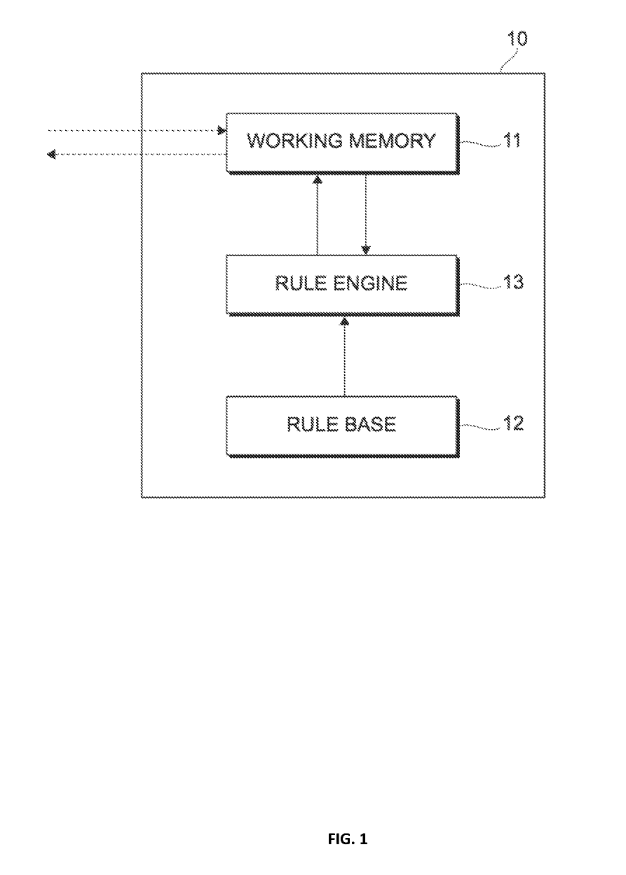

Referring to FIG. 1, there is shown a block diagram of a production system 10 to which the exemplary embodiment is applied. As shown in FIG. 1, the production system 10 may include a working memory 11, a rule base 12, and a rule engine 13.

The working memory 11 may store objects each indicating an internal state (hereinafter the objects are referred to as “internal states”). For example, the internal states may be stored in the working memory 11 by internal processing. Alternatively, assuming that the production system 10 cooperates with an external system serving as one example of an external environment, such as a cognitive system (e.g., artificial intelligence or a robot), observation results may be inputted from the external system and stored in the working memory 11 as the internal states, as indicated by an inbound dashed arrow.

The rule base 12 may store rules, each including a condition part and an action part. The condition part may define conditions to be verified with the internal states stored in the working memory 11. The action part may define actions, each of which is executed when a condition defined by the condition part is satisfied. For example, the actions may include creation, modification, and deletion of an internal state. Alternatively, assuming that the production system 10 cooperates with an external system such as a cognitive system (e.g., artificial intelligence or a robot), the actions may be executed to control the external system.

The rule engine 13 may generally perform the following operation. First, the rule engine 13 may extract from the rule base 12 rules matching the internal states currently stored in the working memory 11, select one rule among the extracted rules, and then fire the selected rule. Secondly, the rule engine 13 may extract again from the rule base 12, rules matching the internal states updated on the basis of the side effect of firing the selected rule, select again one rule among the extracted rules, and then fire again the selected rule. Subsequently, the rule engine 13 may repeat this processing until no rule is extracted.

The production system 10 may be required to be extended by adding an object indicating a special internal state defining an execution context (hereinafter the object is referred to as a “one-time object”), implementing a function to delete the one-time object at the timing when all rules which at least match the one-time object have been fired, and get back to a context of creation of the one-time object. If the production system 10 cooperates with an external system, such as a cognitive system (e.g., artificial intelligence or a robot), the external system may transit into a temporary state of taking on some behavior. Note that it may be difficult to implement this function in the production system 10 with an existing rule matching mechanism since a user may need to know how to control the execution context inside the production system 10. In other words, the user may have difficulty in detecting the timing when all rules which at least match the one-time object have been fired, although the user may be required to detect such timing to know how to control the execution context.

The exemplary embodiment extends the production system 10 so that it has the above function regarding the one-time object. Specifically, the working memory 11 may be extended to temporarily store the one-time object indicating the special internal state created at the timing of an external observation from an external system or created by firing a rule which contains an action of creation of the one-time object, in addition to general internal states. Further, the rule base 12 may be extended so that the action part of each of the rules can define creation of the one-time object, in addition to creation, modification and deletion of the general internal states. The rule engine 13 may be extended to check the condition part of each of the rules with the internal states including the general internal states and the one-time object, to conduct forward reasoning after storing a new context associated with the one-time object created by having fired a rule matching the internal states, and to delete automatically the one-time object when all rules which at least match the one-time object have been fired.

Next, operations of the production system 10 according to the exemplary embodiment is described.

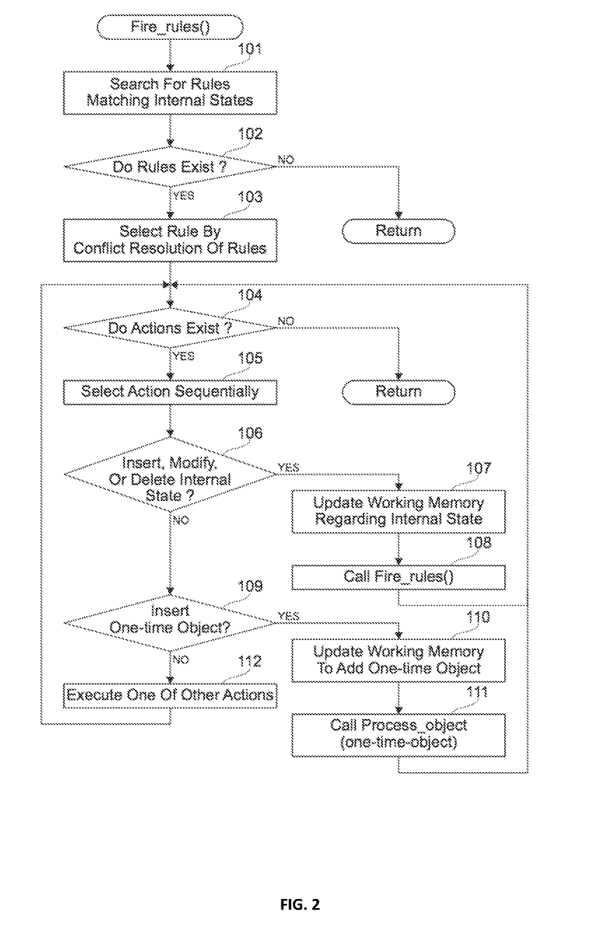

Referring to FIG. 2, a flowchart representing an example of a processing flow of a function “Fire_rules( )” executed by the rule engine 13 of the production system 10 is presented. The function “Fire_rules( )” may be called when content of the working memory 11 is changed. The function “Fire_rules( )” executed in response to this call may serve as one example of claimed forward reasoning conducted at first.

At 101, when the function “Fire_rules( )” is called, the rule engine 13 may search in the rule base 12 for rules matching one or more internal states stored in the working memory 11. The rules matching one or more internal states may include condition parts defining a condition satisfied by the one or more internal states. The internal states may include a one-time object in addition to general internal states. Then, at 102, the rule engine 13 may determine whether or not the rules matching one or more internal states exist in the rule base 12. If such rules do not exist, the rule engine 13 may return the processing to the caller of the function “Fire_rules( )”.

If, at 102, such rules exist, the rule engine 13 may select a rule from the rules by conflict resolution of the rules at 103. The conflict resolution may be a technique for selecting one rule from plural rules matching one or more internal states by predetermined criteria. The predetermined criteria include, for example, criteria for selecting one rule which has been found first to match one or more internal states. Then, at 104, the rule engine 13 may determine whether or not one or more actions exist in the action part of the selected rule. Note that the one or more actions may indicate actions which have not been executed. If such actions do not exist, the rule engine 13 may return the processing to the caller of the function “Fire_rules( )”.

If, at 104, such actions exist, the rule engine 13 may sequentially select an action from the actions at 105. Then, at 106, the rule engine 13 may determine whether or not the selected action is one of “insert an internal state”, “modify an internal state”, and “delete an internal state”. If the selected action is one of “insert an internal state”, “modify an internal state”, and “delete an internal state”, the rule engine 13 may update the working memory 11 regarding the internal state at 107. Specifically, the rule engine 13 may perform insertion of the internal state into the working memory 11, modification of the internal state in the working memory 11, or deletion of the internal state from the working memory 11. Subsequently, the rule engine 13 may recursively call the function “Fire_rules( )” at 108. Meanwhile, in response to the call, the function “Fire_rules( )” may be started with a new context. The function “Fire_rules( )” executed in response to this call may serve as one example of claimed forward reasoning conducted with a second new context. After the function “Fire_rules( )” has ended, the process may be returned to 108. Then, the rule engine 13 may return the processing to 104.

If, at 106, the selected action is none of “insert an internal state”, “modify an internal state”, and “delete an internal state”, the rule engine 13 may determine whether or not the selected action is “insert a one-time object” at 109. If the selected action is “insert a one-time object”, the rule engine 13 may update the working memory 11 to add the newly created one-time object at 110. Subsequently, at 111, the rule engine 13 may call a function “Process_object(one-time-object)” and a context indicating that the one-time object has been created may be set. This context may serve as one example of a claimed context of creation of the one-time object. Meanwhile, in response to the call, the function “Process_object(one-time-object)” may be started. The details of this function will be described later. After the function “Process_object(one-time-object)” has ended, the processing may be returned to 111. Then, the rule engine 13 may return the processing to 104.

If, at 109, the selected action is not “insert a one-time object”, the rule engine 13 may execute one of other actions at 112. The action executable at 112 may be defined by the action part of the selected rule. For example, the action may be executed to control a cognitive system such as a robot. Subsequently, the rule engine 13 may return the processing at 104.

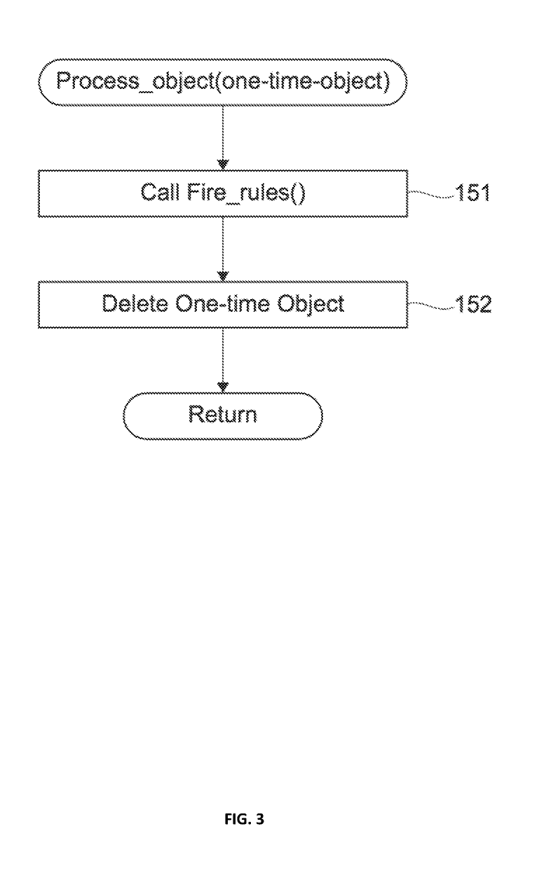

Referring to FIG. 3, there is shown a flowchart representing an example of a processing flow of the function “Process_object(one-time-object)” executed by the rule engine 13 of the production system 10. As stated above, the function “Process_object(one-time-object)” may be called from the function “Fire_rules( )”. Alternatively, the function “Process_object(one-time-object)” may be called when the production system 10 receives an external observation, creates a one-time object corresponding to the external observation, and stores the one-time object in the working memory 11.

At 151, when the function “Process_object(one-time-object)” is called, the rule engine 13 may call the function “Fire_rules( )”. In response to the call, the function “Fire_rules( )” may be started with a new context associated with the one-time object. The function “Fire_rules( )” may be started in the following two ways. The function “Fire_rules( )” executed in response to this call may serve as one example of claimed forward reasoning conducted with a first new context if the function “Process_object(one-time-object)” is called from the recursive caller function “Fire_rules( )”, and serve as one example of claimed forward reasoning conducted with a third new context if the function “Process_object(one-time-object)” is called in response to receiving an external observation. After the function “Fire_rules( )” is completed, the process may be returned to 151. Note that the completion of the function “Fire_rules( )” may be determined based on the end of the new context associated with the one-time object. Then, at 152, the rule engine 13 may delete the one-time object in response to completion of the context of creation of the one-time object set at 111. Subsequently, the rule engine 13 may return the processing to the caller of the function “Process_object(one-time-object)”.

By executing the foregoing operations, the exemplary embodiment may allow a user to define creation of a one-time object in an action part of a rule to reduce programming load. Specifically, in the exemplary embodiment, the user may create an action which can cross-sectionally handle internal states each having a special tag. For example, this action may erase a part of the internal states, or update a field of the part of the internal states, when any special event occurs.

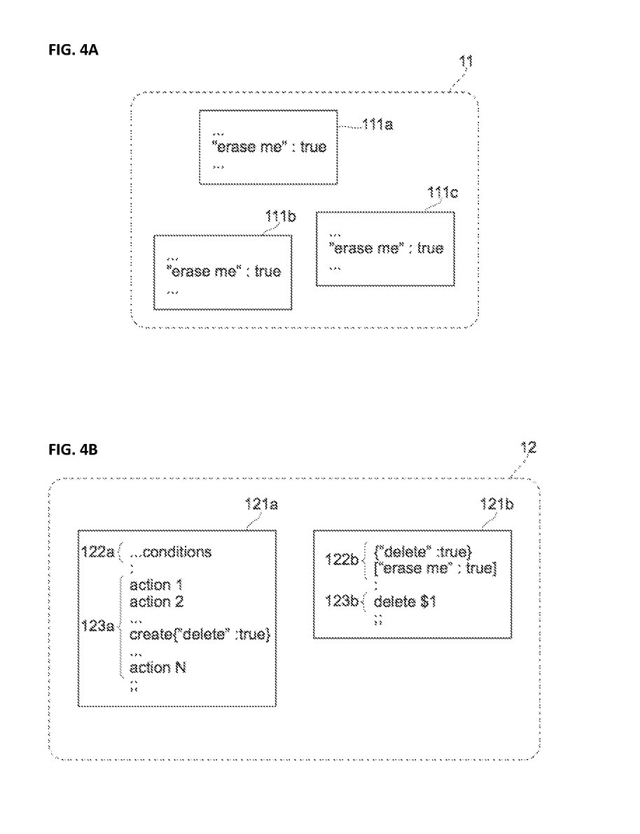

Referring to FIGS. 4A and 4B, there are shown explanatory diagrams of erasure of the internal states created by the production system 10 during processing.

FIG. 4A shows an example of a part of the working memory 11. As shown in the figure, the working memory 11 may store internal states 111a to 111c. Each of the internal states 111a to 111c is assumed to have a tag ““erase me”: true” indicating that the corresponding internal state is required to be erased.

FIG. 4B shows an example of a part of the rule base 12. As shown in the figure, the rule base 12 may store rules 121a and 121b. The rule 121a may include a condition part 122a defining conditions indicated by a description “ . . . conditions”, and an action part 123a defining actions “action 1”, “action 2”, “create {“delete”:true}”, and “action N”. Meanwhile, the rule 121b may include a condition part 122b defining conditions “{“delete”:true}” and “[“erase me”:true]”, and an action part 123b defining an action “delete $1”.

Note that in FIG. 4B, a character string within curly braces is assumed to indicate a one-time object, and a character string within square brackets is assumed to indicate a tag attached to an internal state. Thus, “{“delete”:true}” in the action part 123a is assumed to be a one-time object, and “{“delete”:true}” in the condition part 122b is assumed to be a condition that the one-time object “{“delete”:true}” is stored in the working memory 11. Further, “[“erase me”:true]” in the condition part 122b is assumed to be a condition that an internal state having the tag ““erase me”:true” is stored in the working memory 11.

Furthermore, in FIG. 4B, an internal state (e.g., a one-time object) with the condition in the first row from the top is assumed to be identified by a label “$0”, and an internal state with the condition in the second row from the top is assumed to be identified by a label “$1”. Thus, the action “delete $1” in the action part 123b is assumed to delete an internal state having the tag ““erase me”:true”.

Hereinafter, a case where the function “Fire_rules( )” may handle the rule 121a in the state that the working memory 11 and the rule base 12 are as shown in FIGS. 4A and 4B, respectively, may be assumed.

In this case, first, the actions “action 1” and “action 2” may be executed at 107 or 112.

Next, the action “create {“delete”:true}” may be executed at 110, and the one-time object “{“delete”:true}” may be stored in the working memory 11. Then, a context of creation of the one-time object “{“delete”:true}” may be set, and the “Process_object(one-time-object)” may be called at 111. Note that the context of creation of the one-time object may be used to determine whether or not the one-time object is to be deleted at 152, as described later.

After the function “Process_object(one-time-object)” has started, the function “Fire_rules( )” may be called at 151. At this time, the one-time object “{“delete”:true}” and the internal state 111a having the tag ““erase me”:true” may have been stored in the working memory 11, and the conditions in the condition part 122b may be satisfied. Thus, the internal state 111a may be erased by execution of the action “delete $1” in the action part 123b. Further, at this time, the one-time object “{“delete”:true}” and the internal state 111b having the tag ““erase me”:true” may have been stored in the working memory 11, and the conditions in the condition part 122b may be satisfied. Thus, the internal state 111b may be erased by execution of the action “delete $1” in the action part 123b. Furthermore, at this time, the one-time object “{“delete”:true}” and the internal state 111c having the tag ““erase me”:true” may have been stored in the working memory 11, and the conditions in the condition part 122b may be satisfied. Thus, the internal state 111c may be erased by execution of the action “delete $1” in the action part 123b.

Consequently, assuming that no internal state having the tag ““erase me”:true” is stored in the working memory 11, the conditions in the condition part 122b may become unsatisfied. Thus, the processing may be returned to the context of creation of the one-time object, and the one-time object may be deleted at 152. Subsequently, the function “Process_object(one-time-object)” is ended, and the action “action N” may be executed at 107 or 112.

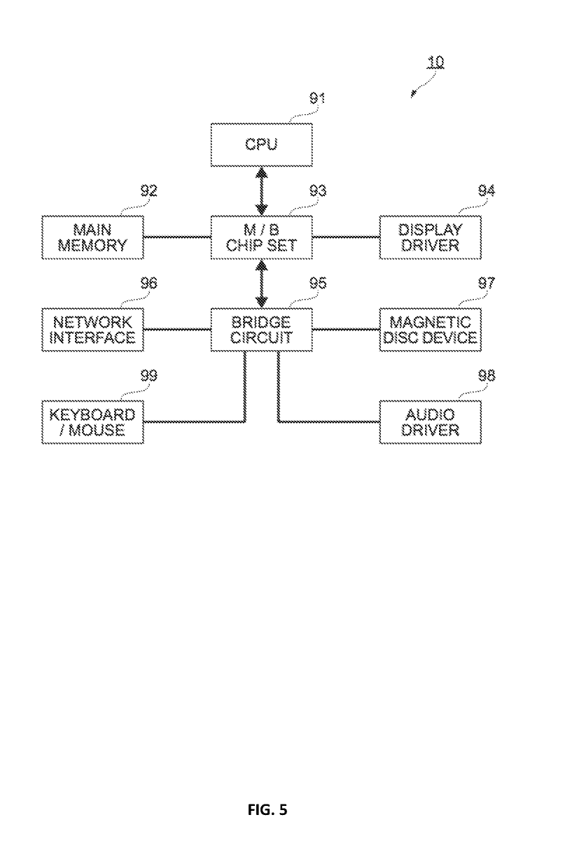

Referring to FIG. 5, there is shown an example of a hardware configuration of the production system 10 in the exemplary embodiment. As shown in FIG. 5, the production system 10 may include a central processing unit (CPU) 91 serving as one example of a processor, a main memory 92 connected to the CPU 91 via a motherboard (M/B) chip set 93 and serving as one example of a memory, and a display driver 94 connected to the CPU 91 via the same M/B chip set 93. A network interface 96, a magnetic disk device 97, an audio driver 98, and a keyboard/mouse 99 are also connected to the M/B chip set 93 via a bridge circuit 95.

In FIG. 5, the various configurational elements are connected via buses. For example, the CPU 91 and the M/B chip set 93, and the M/B chip set 93 and the main memory 92 are connected via CPU buses, respectively. Also, the M/B chip set 93 and the display driver 94 may be connected via an accelerated graphics port (AGP). However, when the display driver 94 includes a PCI express-compatible video card, the M/B chip set 93 and the video card are connected via a PCI express (PCIe) bus. Also, when the network interface 96 is connected to the bridge circuit 95, a PCI Express may be used for the connection, for example. For connecting the magnetic disk device 97 to the bridge circuit 95, a serial AT attachment (ATA), a parallel-transmission ATA, or peripheral components interconnect (PCI) may be used. For connecting the keyboard/mouse 99 to the bridge circuit 95, a universal serial bus (USB) may be used.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for conducting forward reasoning, the method comprising:
conducting the forward reasoning, wherein the forward reasoning includes selecting a rule from a plurality of rules stored in a rule base and executing an action, wherein the rule is associated with a condition satisfied by internal states stored in a working memory, and wherein the action is associated with the condition;
detecting the action is creating a one-time object;
conducting the forward reasoning with a first new context in response to the detected one-time object, wherein the one-time object is stored as one of the internal states in the working memory; and
deleting the one-time object in response to a completion of the forward reasoning with the first new context.

2. The method of claim 1, further comprising:
setting a context of creation of the one-time object prior to conducting the forward reasoning with the first new context in response to the detected one-time object; and
deleting the one-time object in response to the completion of the forward reasoning with the first new context based on the context of creation of the one-time object.

3. The method of claim 1, further comprising:
completing the forward reasoning with the first new context in response to an end of the first new context.

4. The method of claim 1, further comprising:
detecting the action is changing the internal states stored in the working memory; and
conducting the forward reasoning with a second new context in a state where the change has been made to the internal states stored in the working memory in response to the detected change.

5. The method of claim 1, further comprising:
detecting an observation result has been input from an external environment; and
conducting the forward reasoning with a third new context in the state where the one-time object is stored as one of the internal states in the working memory.

6. A computer system for conducting forward reasoning, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
conducting the forward reasoning, wherein the forward reasoning includes selecting a rule from a plurality of rules stored in a rule base and executing an action, wherein the rule is associated with a condition satisfied by internal states stored in a working memory, and wherein the action is associated with the condition;
detecting the action is creating a one-time object;
conducting the forward reasoning with a first new context in response to the detected one-time object, wherein the one-time object is stored as one of the internal states in the working memory; and
deleting the one-time object in response to a completion of the forward reasoning with the first new context.

7. The computer system of claim 6, further comprising:
setting a context of creation of the one-time object prior to conducting the forward reasoning with the first new context in response to the detected one-time object; and
deleting the one-time object in response to the completion of the forward reasoning with the first new context based on the context of creation of the one-time object.

8. The computer system of claim 6, further comprising:
completing the forward reasoning with the first new context in response to an end of the first new context.

9. The computer system of claim 6, further comprising:
detecting the action is changing the internal states stored in the working memory; and
conducting the forward reasoning with a second new context in a state where the change has been made to the internal states stored in the working memory in response to the detected change.

10. The computer system of claim 6, further comprising:
detecting an observation result has been input from an external environment; and
conducting the forward reasoning with a third new context in the state where the one-time object is stored as one of the internal states in the working memory.

11. A computer program product for conducting forward reasoning in a production system, comprising:
one or more computer-readable storage medium and program instructions stored on at least one of the one or more tangible storage medium, the program instructions executable by a processor, the program instructions comprising:
program instructions to conduct the forward reasoning, wherein the forward reasoning includes selecting a rule from a plurality of rules stored in a rule base and executing an action, wherein the rule is associated with a condition satisfied by internal states stored in a working memory, and wherein the action is associated with the condition;
program instructions to detect the action is creating a one-time object;
program instructions to conduct the forward reasoning with a first new context in response to the detected one-time object, wherein the one-time object is stored as one of the internal states in the working memory; and
program instructions to delete the one-time object in response to a completion of the forward reasoning with the first new context.

12. The computer program product of claim 11, further comprising:
program instructions to set a context of creation of the one-time object prior to conducting the forward reasoning with the first new context in response to the detected one-time object; and
program instructions to delete the one-time object in response to the completion of the forward reasoning with the first new context based on the context of creation of the one-time object.

13. The computer program product of claim 11, further comprising:
program instructions to complete the forward reasoning with the first new context in response to an end of the first new context.

14. The computer program product of claim 11, further comprising:
program instructions to detect the action is changing the internal states stored in the working memory; and
program instructions to conduct the forward reasoning with a second new context in a state where the change has been made to the internal states stored in the working memory in response to the detected change.

15. The computer program product of claim 11, further comprising:
program instructions to detect an observation result has been input from an external environment; and
program instructions to conduct the forward reasoning with a third new context in the state where the one-time object is stored as one of the internal states in the working memory.
